(19) United States
(12) Patent Application Publication
(10) Pub. No.: US 2002/0095104 A1
(43) Pub. Date: Jul. 18, 2002

(54) Cushion-base electric mobile massaging device

(76) Inventor: Chao-Yang Chen, Taipei (TW)

Correspondence Address: BACON & THOMAS, PLLC, 625 Slaters Lane - 4th Floor, Alexandria, VA, 22314-1176, US

(21) Appl. No.: 09/761,687

(22) Filed: Jan. 18, 2001

(51) Int. Cl. A61H 1/00

(52) U.S. Cl. 601/56

(57) ABSTRACT

A cushion-base electric mobile massaging device is disclosed for massaging the user's feet/back, including a covering, a cushion, an electric massaging assembly, and at least one shoe upper. In an alternate form of the invention, the cushion-base electric mobile massaging device includes two symmetrical cushion-base massaging units that can be fastened together to massage the user's back, or separately put on the user's feet to massage the sole of each foot.

### BACKGROUND OF THE INVENTION

1. Field of the Invention

The present invention relates to an electric massaging device and, more particularly, to a cushion-base electric mobile massaging device.

2. Description of Related Art

Various electric massaging apparatus including electric massaging beds, electric massaging chairs, foot massagers, electric massaging sticks, electric massaging pens, and etc. are commercially available in department stores and sports shops. Exemplars of foot massagers are seen in Taiwan Patent Publication No. 407499, No. 399462, No. 383595, No. 375036, No. 362481, and No. 355363.

Regular foot massagers are commonly complicated and expensive. Further, in order not to slip from the user's foot, regular foot massagers are commonly heavy. Therefore, it is desirable to provide a simple, compact, inexpensive foot massaging device, which does not slip from the user's foot, has an automatic switching function, and can be alternatively used as a back massager.

### SUMMARY OF THE INVENTION

The present invention has been accomplished under the circumstances in view. The main object of the present invention is to provide a cushion-base electric mobile massaging device, which is compact and inexpensive, and has a simple structure and an automatic switching function. It is another object of the present invention to provide a cushion-base electric mobile massaging device, which is compact and does not slip when used to massage the user's feet. It is still another object of the present invention to provide a cushion-base electric mobile massaging device, which can be used as a back massager. It is still another object of the present invention to provide a cushion-base electric mobile massaging device, which can quickly be separated into two independent massaging units, or combined into a united electric mobile massaging cushion.

To achieve the object, the cushion-base electric mobile massaging device according to the first embodiment of the present invention comprises a covering, a cushion, an electric massaging assembly, and at least one shoe upper. The electric massaging assembly comprises a substrate, a vibration motor, a power supply (for example, a battery set), and a contact switch. This design of electric massaging assembly can easily be achieved by the known techniques. The cushion has an open chamber adapted to receive the electric massaging assembly. The cushion can be made of natural sponge, synthetic sponge, foam material, inflatable material, cotton, cloth, or paper. The covering comprises a receiving space, a top face, and a peripheral wall. The cushion and the electric massaging assembly are installed in the receiving space of the covering. The material and structure of the covering are similar to the covering of a regular seat cushion. For example, the covering can be made of fabric or plastic cloth. The shoe upper is fixedly provided at the top face of the covering, and can be constructed subject to any of a variety of designs. For example, the shoe upper can be constructed like the upper of a slipper, or an oxford. The shoe upper may be provided with an elastic band to fit different sizes. The top face of the covering may be provided with one shoe upper, or a pair of shoe uppers. According to the second embodiment of the present invention, the cushion-base electric mobile massaging device is comprised of two cushion-base massaging units that can be separately put on the user's feet, or secured together to form a back massager. The two cushion-base massaging units are provided with a respective fastening device for fastening. The fastening structure of the fastening devices of the cushion-base massaging units can be hook and loop materials, a zip fastener, a set of hook and eye, a snap, or the like.

Other objects, advantages, and novel features of the invention will become more apparent from the following detailed description when taken in conjunction with the accompanying drawings.

### BRIEF DESCRIPTION OF THE DRAWINGS

FIG. 1 is an exploded view of a cushion-base electric mobile massaging device according to a first embodiment of the present invention.

FIG. 2 is a cutaway view of the cushion-base electric mobile massaging device according to the first embodiment of the present invention.

FIG. 3 is a perspective view of a cushion-base electric mobile massaging device according to a second embodiment of the present invention.

FIG. 4 is an applied view of the second embodiment of the present invention, showing the two massaging units of the cushion-base electric massaging device fastened together and attached to the back of a chair.

### DETAILED DESCRIPTION OF THE PREFERRED EMBODIMENT

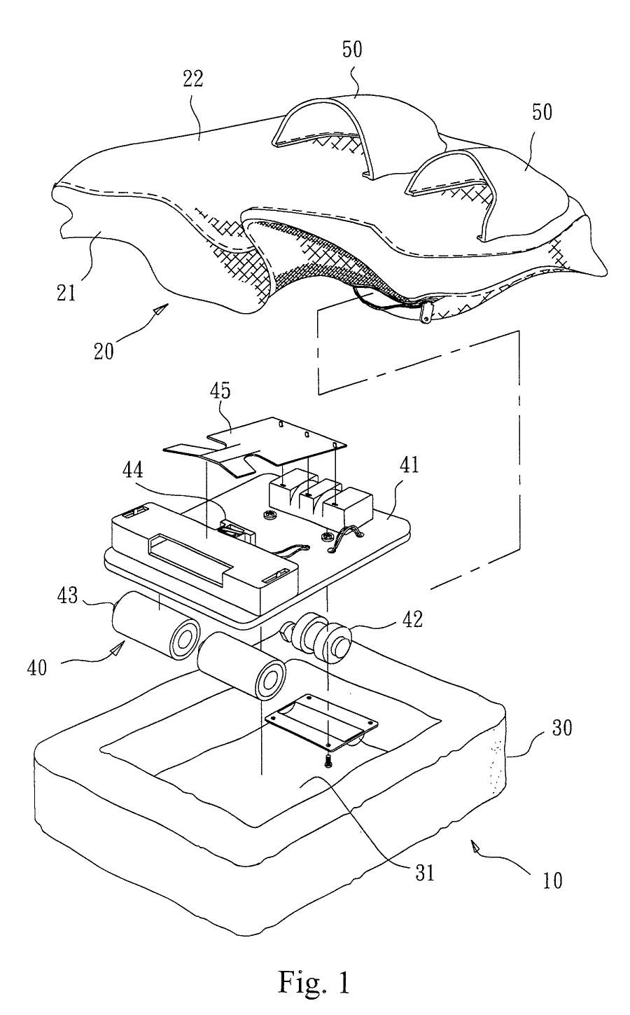

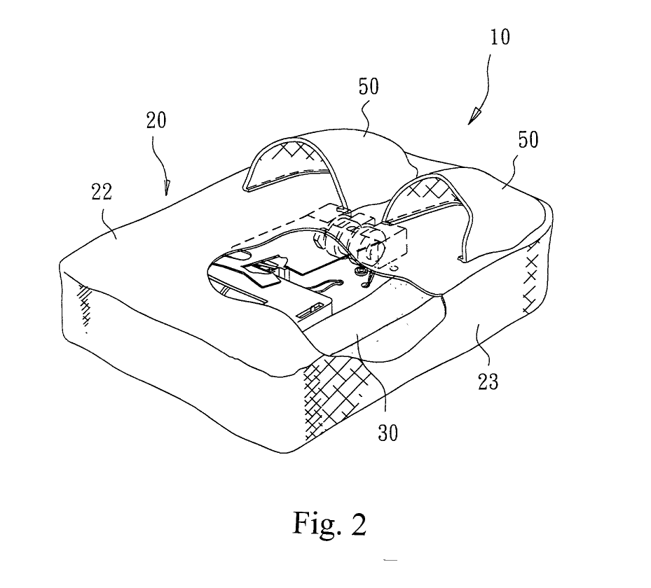

With reference to FIGS. 1 and 2, there is shown a cushion-base electric mobile massaging device constructed according to a first embodiment of the present invention, and comprised of a covering (cloth cover) 20, a cushion (foam material) 30, an electric massaging assembly 40, and at least one, for example, two shoe uppers 50.

The electric massaging assembly 40 comprises a substrate 41, a vibration motor 42, a power supply (battery set) 43, and a contact switch 44. In order to facilitate the control of the contact switch 44, a spring plate 45 is provided above the contact switch 44. The spring plate 45 provides a big operation area. When applying a pressure to the spring plate 45 (by the feet or the back), the spring plate 45 is forced to switch on the contact switch 44. On the contrary, when releasing the pressure from the spring plate 45, the contact switch 44 is switched off. The cushion 30 is a hollow member defining an open chamber 31. The electric massaging assembly 40 is set in the open chamber 31 of the cushion 30. After the electric massaging assembly 40 has been set in the open chamber 31 of the cushion 30, the cushion 30 and the electric massaging assembly 40 are positioned in the receiving space 21 inside the covering 20.

The covering 20 comprises a top face 22 and a peripheral wall 23. The shoe uppers 50 are fixedly provided at the top face 22 of the covering 20 on the outside. Preferably, the shoe uppers 50 are made of soft material for comfort use.

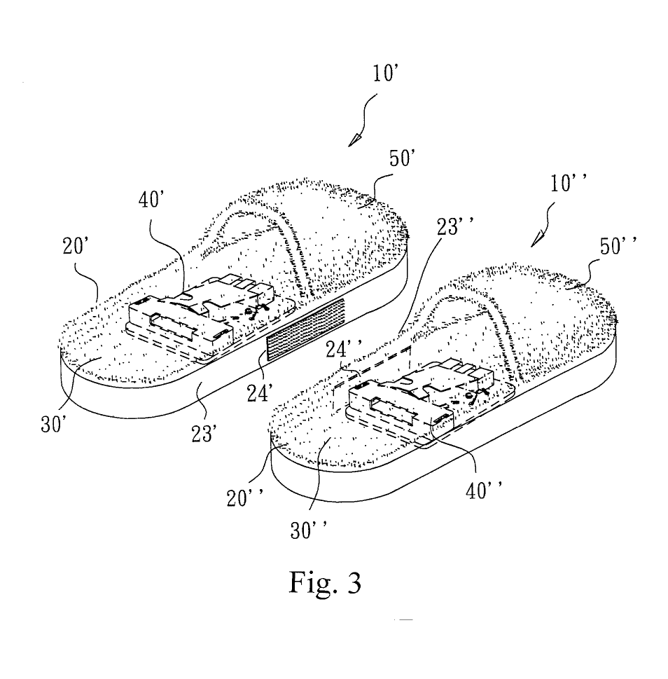

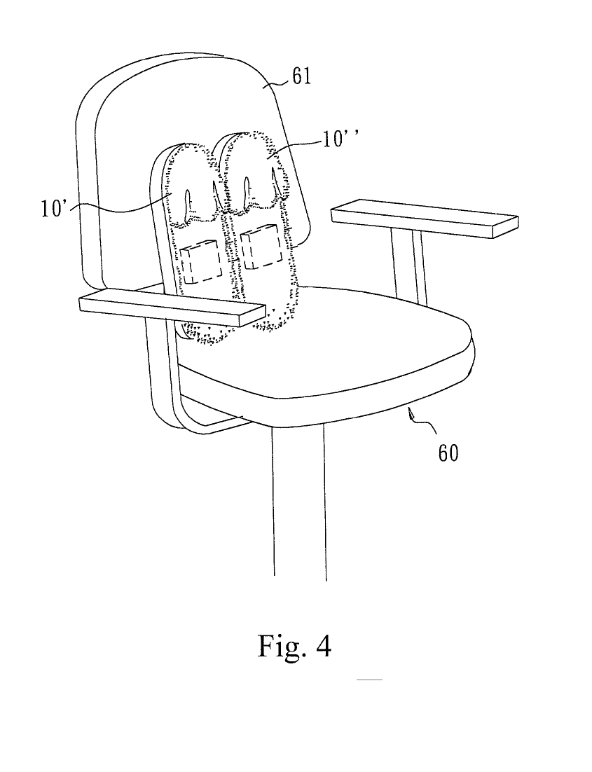

FIGS. 3 and 4 show a cushion-base electric mobile massaging device according to a second embodiment of the present invention. According to this embodiment, the cushion-base electric mobile massaging device is twin design comprised of two massaging units 10′ and 10″.

Referring to FIG. 3 again, the first massaging unit 10′ comprises a covering 20′, a cushion 30′, an electric massaging assembly 40′, and a shoe upper 50′. Similar to the first massaging unit 10′, the second massaging unit 10″ is also comprised of a covering 20″, a cushion 30″, an electric massaging assembly 40″, and a shoe upper 50″. The detailed structure and operation principle of the first massaging unit 10′ and the second massaging unit 10″ are similar to the cushion-base electric mobile massaging device shown in FIGS. 1 and 2.

The covering 20′ of the first massaging unit 10′ has a fastening device 24′ disposed at one side thereof. The covering 20″ of the second massaging unit 10″ has a fastening device 24″ disposed at one side thereof, and adapted for detachably fastening to the fastening device 24′ of the first massaging unit 10′. The fastening devices 24′ and 24″ are hook and loop materials (one strip of hook material and one strip of loop material).

When in use, as shown in FIG. 3, the first massaging unit 10′ and the second massaging unit 10″ are separated from each other and used as a pair of shoes. When the user puts the feet in the shoe uppers 50′ and 50″, the electric massaging assemblies 40′ and 40″ of the massaging units 10′ and 10″ are automatically turned on to massage the feet. Because the first massaging unit 10′ and the second massaging unit 10″ function as a pair of shoes, the cushion-base electric mobile massaging device does not slip from the feet when the user walks or runs.

Referring to FIG. 4 again, the first massaging unit 10′ and the second massaging unit 10″ can be fastened together and supported on the back 61 of a chair 60 to massage the user's back.

Although the present invention has been explained in relation to its preferred embodiments, it is to be understood that many other possible modifications and variations can be made without departing from the spirit and scope of the invention as hereinafter claimed.

What is claimed is:

1. A cushion-base electric mobile massaging device comprising:
a covering, said covering comprising a receiving space, a top face, and a peripheral wall;
a cushion set in the receiving space of said covering, said cushion comprising an open chamber;
an electric massaging assembly positioned in the open chamber of said cushion, said electric massaging assembly comprising a substrate, a vibration motor, a power supply, and a contact switch; and
at least one shoe upper fixedly provided at the top face of said covering.

2. The cushion-base electric mobile massaging device as claimed in claim 1 wherein said cushion is made of material selected from natural sponge, synthetic sponge, foam material, inflatable means, cotton, cloth, and paper.

3. The cushion-base electric mobile massaging device as claimed in claim 1 wherein said power supply is a battery set.

4. The cushion-base electric mobile massaging device as claimed in claim 1 wherein the number of said at least one shoe upper is 2.

5. The cushion-base electric mobile massaging device as claimed in claim 1 wherein said electric massaging assembly further comprises a spring plate suspended above said contact switch and disposed in contact with the top of said covering for triggering said contact switch upon an external pressure.

6. A cushion-base electric mobile massaging device comprising:
a first covering, said covering comprising a receiving space, a top face, a peripheral wall, and a fastening device provided at the peripheral wall of said first covering;
a first cushion set in the receiving space of said first covering, said first cushion comprising an open chamber;
a first electric massaging assembly positioned in the open chamber of said first cushion, said first electric massaging assembly comprising a substrate, a vibration motor, a power supply, and a contact switch;
a first shoe upper fixedly provided at the top face of said covering;
a second covering, said second covering comprising a receiving space, a top face, a peripheral wall, and a fastening device provided at the peripheral wall of said second covering;
a second cushion set in the receiving space of said second covering, said second cushion comprising an open chamber;
a second electric massaging assembly positioned in the open chamber of said second cushion, said second electric massaging assembly comprising a substrate, a vibration motor, a power supply, and a contact switch; and
a second shoe upper fixedly provided at the top face of said second covering.

7. The cushion-base electric mobile massaging device as claimed in claim 5 wherein said first cushion and said second cushion are made of material selected from natural sponge, synthetic sponge, foam material, inflatable means, cotton, cloth, and paper.

8. The cushion-base electric mobile massaging device as claimed in claim 5 wherein the fastening devices of said first covering and said second covering are hook and loop materials.

9. The cushion-base electric mobile massaging device as claimed in claim 5 wherein said first covering, said first cushion, said first electric massaging assembly and said first shoe upper form a first cushion-base massaging unit, said second covering, said second cushion, said second electric massaging assembly and said second shoe upper form a second cushion-base massaging unit, and said first cushion-base massaging unit and said second cushion-base massaging unit form a pair of shoes.

10. The cushion-base electric mobile massaging device as claimed in claim 9 wherein the fastening devices of said first covering and said second covering are fastened to each other, keeping said first cushion-base massaging unit and said second cushion-base massaging unit secured together to form a cushion-base back massager.
